(19) United States
(12) Patent Application Publication
(10) Pub. No.: US 2009/0069957 A1
(43) Pub. Date: Mar. 12, 2009

(54) UNMANNED HELICOPTER

(75) Inventor: Katsu Nakamura, Shizuoka-ken (JP)

Correspondence Address: KNOBBE MARTENS OLSON & BEAR LLP, 2040 MAIN STREET, FOURTEENTH FLOOR, IRVINE, CA, 92614, US

(73) Assignee: Yamaha Hatsudoki Kabushiki Kaisha, Shizuoka-ken (JP)

(21) Appl. No.: 11/910,219

(22) PCT Filed: Mar. 28, 2006
(86) PCT No.: PCT/JP2006/306327

§ 371 Date: Sep. 28, 2007

(30) Foreign Application Priority Data
Mar. 28, 2005 (JP) 2005-091914

(51) Int. Cl. G05D 1/00

(52) U.S. Cl. 701/3

(57) ABSTRACT

GPS devices (GPS receivers and corresponding GPS antennas) for detecting a location of an airframe are provided. An autonomous control section (e.g., an autonomous control box) including a data communication device for communicating with the ground and a control board having a built-in control program is provided. An unmanned helicopter flies depending on airframe data such as an attitude and a speed of the airframe, engine speed, and a throttle angle and flight data such as a location and a direction of the airframe. The autonomous control section is provided with a plurality of different type of GPS devices.

### CROSS-REFERENCE TO RELATED APPLICATIONS

This application is a U.S. National Phase of the International Application No. PCT/JP2006/306327 filed Mar. 28, 2006 designating the U.S. and published in Japanese on May 10, 2006 as WO 2006/104158, which claims priority of Japanese Patent Application No. 2005-091914, filed Mar. 28, 2005.

### BACKGROUND OF THE INVENTION

1. Field of the Invention

The present invention relates to an unmanned helicopter for performing a program flight by autonomous control, and more particularly to Global Positioning System (GPS) sensor for detecting a location of the unmanned helicopter and to a method of using the same.

2. Description of the Related Art

Conventionally, a movie camera or a still camera mounted on a helicopter is used for photographing a view from the sky. In recent years in particular, such cameras have been mounted on an unmanned helicopter (as described in Japanese Publication JP 2002-166893, for example) that flies by remote control from the ground via a radio controller or the like, or that flies on a preprogrammed route (or a program flight). Thus, an unmanned helicopter can be used to take an aerial photograph of a place where a manned helicopter cannot fly.

Characteristically, an attitude of the airframe of the unmanned helicopter is easily disturbed by wind or the like. Further, structural features of the unmanned helicopter can result in extreme changes in attitude during a flight while a turn is made. An attitude of the unmanned helicopter is controlled mainly by servo motors of various types mounted on the airframe to change a tilt angle of the shaft of a main rotor and a tilt angle of a blade of the main rotor and the tail rotor. Further, if the unmanned helicopter of such a type is, for example, caught by a strong crosswind, the flight route may extremely deviate from an intended flight route. Accordingly, there may be a case in which autonomous control takes a long time to correct a flight route.

In order to get a status of the airframe or a flight and to appropriately control the helicopter from the ground, communication means is provided for transmitting data between the airframe of the helicopter and a ground station. The status of the aircraft described above includes an operation of a servo motor for controlling an attitude of the aircraft, an operation status of an engine, the operation status of various types of sensors for detecting a tilt angle of the airframe and engine speed, a battery charge status of a battery mounted on the airframe, and so forth. On the other hand, the status of the flight described above includes a current flight status in relation to a flight route, such as a flying direction, an altitude, and a location of the unmanned helicopter, an operation status of a GPS device showing whether or not the GPS device is operating correctly, and so forth. Data on the status of the aircraft, the flight, and so forth is transmitted from the airframe to a ground station and, displayed on a monitor screen of a computer provided to the ground station.

One of the sensors for performing a program flight by autonomous control is a GPS, which allows for the accurate detection of a current location of the unmanned helicopter in order to accurately fly following a predefined route.

The GPS (Global Positioning System) has become familiar with the spread of car navigation systems in recent years. The GPS utilizes information transmitted from the 24 GPS satellites (four such satellites are arranged in each one of six orbits) that move around the Earth in circular orbits (of about 20,000 km in the sky). This system facilitates obtaining a current location (latitude, longitude, and altitude) of a user, their speed, and time.

Radio waves used by the GPS are high-frequency waves (1.5 GHz), and therefore their characteristics are similar to those of light. Accordingly, if there is a metal object, a building, a mountain, a machine, a man, a bird, or the like in a space between the satellite and a GPS antenna provided on the unmanned helicopter, the accuracy of a sensed location of the helicopter may be deteriorated, or a radio wave may not be received. In addition, since the GPS satellites are managed by the United States Department of Defense, usage thereof may be restricted in a case of a national emergency.

There are two types of positioning systems which detect a location by using the GPS as shown in FIG. 9. A first positioning system is a single positioning system 100 with a single GPS 101 utilizing solely signals from GPS satellites. A second positioning system is a relative positioning system 110 including a base station on the ground for receiving information from GPS satellites and transmitting the information by radio, and a mobile object such as a vehicle, a watercraft, and an aircraft. Such a mobile object receives signals from GPS satellites and radio data from the base station, and improves the accuracy of the position of the object via a calculation based on the GPS signals and radio data.

Such relative positioning systems include the Differential GPS (hereinafter referred to as the DGPS) 111, which is less expensive, has a relatively high accuracy, and is usable in a location far away from the base station, and the Real Time Kinematic GPS (hereinafter referred to as the RTK-GPS) 112, which has a higher accuracy than the DGPS.

The Single GPS 101 has one GPS receiver and an antenna. The GPS receiver measures a propagation time of a code transmitted from the satellite by a radio wave (a carrier wave) in order to calculate a location. The GPS receiver is inexpensive and has a simple structure. In addition, the GPS receiver advantageously can perform a calculation at a high speed in order to effect control. The positioning accuracy of the GPS receiver, however, includes an error of about 15 m to 100 m because the positioning accuracy depends on a reception accuracy of a radio wave from the satellites.

The DGPS 111 includes a base station provided on the ground where the position has been accurately measured, and a mobile station provided in a mobile unit such as a vehicle, a watercraft, and an aircraft. The base station measures a propagation time of a code transmitted from the satellite by a radio wave (a carrier wave) and calculates the location of the base station. In addition to this, the base station compares location data already known with the location data obtained by calculation and obtains correction data, such as an error rate, of a GPS signal and the like.

The base station transmits the correction data to a mobile station by a radio wave. As for such a radio wave, an FM broadcast wave is used for a car navigation system in general or the like. Various frequencies and types of radio waves, however, are available. Such a mobile station uses the correction data to perform a calculation for correcting data measured solely by the mobile station based on a signal received from the satellite. Thus, a current location is obtained. According to the DGPS 111, a location of a mobile unit can be detected in a relatively inexpensive and simple manner with higher accuracy than that of the Single GPS.

Unlike the Single GPS 101 or the DGPS 111, the RTK-GPS 112 does not measure the propagation time of the code carried by a carrier wave, but the RTK-GPS 112 is a technique for measuring a phase of a radio wave (a carrier wave) to enable measurement of a location with high accuracy (within centimeters).

The RTK-GPS 112 is provided with a standard station in addition to the constitution of the DGPS 111. As soon as the standard station receives data from the base station, the standard station continuously observes radio waves (carrier waves) from the satellite, measures a carrier phase accumulation value, and transmits phase data to a mobile station. The mobile station continuously observes radio waves (carrier waves) from the satellite and calculates phase data. At the same time, the mobile station calculates a double phase difference based on data transmitted from the standard station. By obtaining a double phase difference as described above, the mobile station eliminates an error factor and specifies a correct location of the mobile station from a group of lattice points for each wavelength distributed in three dimensions.

In addition to this, the mobile station initializes (determines an integer bias) for every wavelength (19 cm) in order to detect an absolute distance from the satellite. For such an initialization, the mobile station needs to constantly receive signals from five or more satellites. If a signal is missed only for a moment, the mobile station needs to initialize again. Once an initialization is finished, the location accuracy obtained is maintained as long as communication is kept established with four or more satellites. The location accuracy is further maintained by initializing again if a radio wave from a satellite is momentarily interrupted and becomes discontinuous. It does not become a problem if data from the base station is not received sometimes.

A positioning system utilizing the GPS (hereinafter referred to as a GPS device) is enabled by receiving radio waves from GPS satellites. Therefore, an operation thereof is not always secure. An operation may be disabled because of an environment or a situation such as an interruption of a satellite radio wave by an obstacle or the like. In particular, a GPS device having high accuracy such as the RTK-GPS described above needs to constantly receive phase data from four or five GPS satellites or more and a standard station. An operation of such a GPS device is disabled problematically if the number of GPS satellites from which a radio wave is received is less than a necessary number or if data from the standard station is not received.

The unmanned helicopter is provided with an automatic return program with which the unmanned helicopter automatically returns toward the ground station (or a predefined, safe landing site or the like) when a receiving state of transmission data from the ground station is deteriorated as described above. Such an unmanned helicopter provided with such an automatic return program, however, causes a problem when the helicopter cannot receive radio waves from GPS satellites. Specifically, because the RTK-GPS positioning system is not sufficient for detecting a current location necessary for performing autonomous control, the automatic return program cannot function.

### SUMMARY OF THE INVENTION

In view of the circumstances noted above, an aspect of the least one of the embodiments disclosed herein is to assist the GPS sensors for performing a program flight by autonomous control, in an unstable characteristic accompanying the usage thereof. Specifically, an object of the present invention is to provide a system that can detect a current location of the unmanned helicopter and thereby perform a program flight by autonomous control even if the number of GPS satellites from which the system receives signals (which can be radio waves) is less than a desired number of satellites, or even if data communication is interrupted.

In accordance with one aspect of the invention, an unmanned helicopter is provided. The unmanned helicopter comprises an airframe with a plurality of GPS antennas disposed thereon, the GPS antennas configured to receive a signal from at least one GPS satellite. The unmanned helicopter also comprises an autonomous controller configured to control the helicopter based at least in part on airframe data and flight route data and to communicate with a ground station, the controller comprising a plurality of GPS receivers, each receiver corresponding to one of the plurality of GPS antennas and defining therewith a GPS device configured to detect a location of the airframe, the GPS devices being different from each other.

In accordance with another aspect of the invention, an unmanned helicopter is provided. The unmanned helicopter comprises an airframe with a plurality of GPS antennas disposed thereon, the GPS antennas configured to receive a signal from at least one GPS satellite, the GPS antennas being spaced apart from each other a length of between one wavelength and two wavelengths of a radio wave of the signal from the GPS satellite. The unmanned helicopter also comprises an autonomous controller configured to navigate the helicopter based at least in part on airframe data and flight route data and to communicate with a ground station, the controller comprising a plurality of GPS receivers, each receiver corresponding to one of the plurality of GPS antennas and defining therewith a GPS device configured to detect a location of the airframe, the GPS devices being different from each other.

In accordance with another aspect of the invention, a method for operating an unmanned helicopter having a plurality of GPS devices, comprising assigning a priority to a plurality of GPS devices on the helicopter, determining whether the GPS device with the first priority is usable, and sensing a location of the helicopter with the GPS device with the first priority when the GPS device with the first priority is usable.

### BRIEF DESCRIPTION OF THE DRAWINGS

FIG. 1 shows a schematic side view of an unmanned helicopter according to one embodiment.

FIG. 2 shows a schematic top view of the unmanned helicopter in FIG. 1.

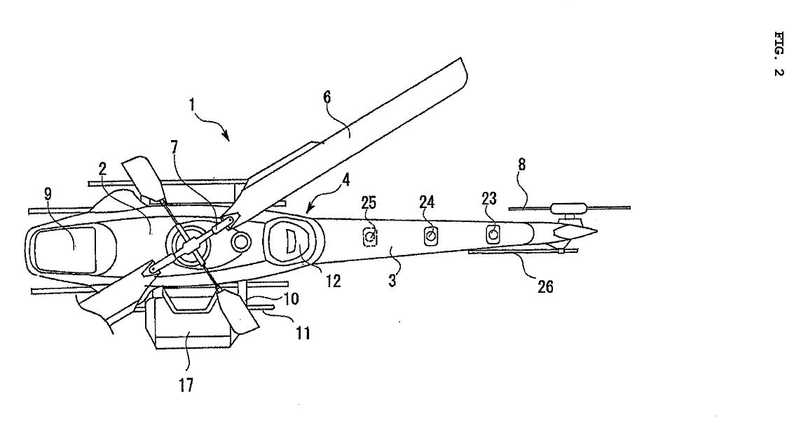

FIG. 3 shows a schematic front view of the unmanned helicopter in FIG. 1.

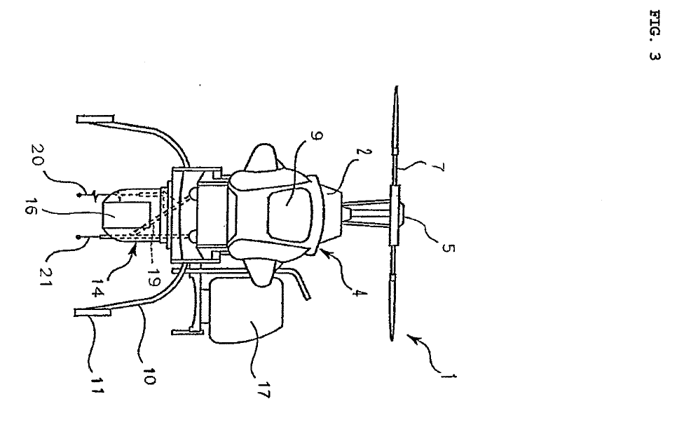

FIG. 4 shows a block diagram of the unmanned helicopter according to one embodiment.

FIG. 5 shows a block diagram of a ground station.

FIG. 6 shows an explanatory drawing of an arrangement of GPS antennas.

FIG. 7 shows a table indicating a priority of the GPS.

FIG. 8 shows a flow chart illustrating a switching control of the GPS.

FIG. 9 shows an explanatory drawing illustrating conventional GPS.

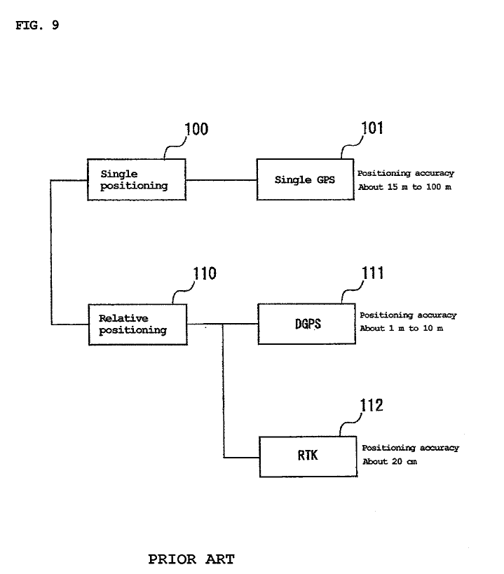

### DETAILED DESCRIPTION OF THE PREFERRED EMBODIMENTS

A helicopter 1 has an airframe 4 including a main body 2 and a tail body 3.

A main shaft 5 which rotates with a torque from an engine (not shown) is provided in the upper part of the main body 2. A main rotor 6 is connected with the main shaft 5 through a rotor support section 7. A tail rotor 8 is provided to the rear part of the tail body 3. A radiator 9 is provided to the front part of the main body 2. A skid 11 is provided via a support leg 10 at the left and the right sides and generally in the center part of the airframe 4 under the main body 2.

A control panel 12 is provided on the upper side of the rear part of the main body 2, while an indicating lamp 13 is provided on the lower side thereof. The control panel 12 displays a checkpoint, self diagnosis result and the like before a flight. A display on the control panel 12 can be confirmed also at a ground station. The indicating lamp 13 displays a state of a GPS control (the type of a GPS device currently in use, for example), an abnormality warning of the airframe 4, and so forth.

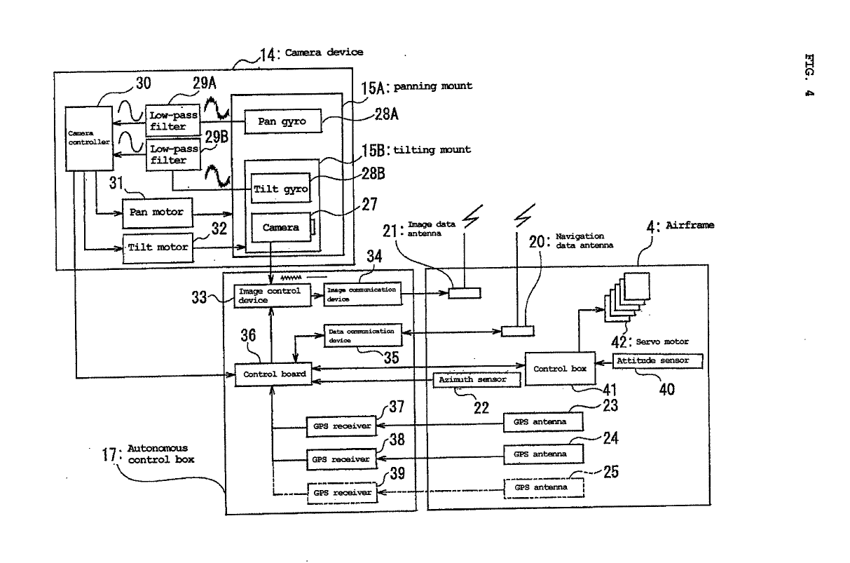

A camera device 14 housing an infrared camera (or a CCD camera) can be mounted under the front part of the main body 2 via a camera mount 15. A camera 27 mounted on the camera mount 15 (refer to FIG. 4) rotates around a pan shaft (a vertical shaft) and is rotatable around a tilt shaft (a horizontal shaft). The camera 27 of the camera device 14 can therefore record a picture in all directions from the sky through a window 16 at the front of the camera device 14.

An autonomous control box 17 is mounted at the left of the main body 2. The autonomous control box 17 houses a GPS device for autonomous control of the helicopter 1, a data communication device or an image communication device for communicating with the ground, a control board with a control program built in, and so forth. During autonomous control, an operation mode and a control program prescribed in advance are selected automatically or according to an instruction from the ground station depending on various data described below. Thus, navigation control optimal for the state of the airframe and flight can be performed. The various data described above include airframe data such as an attitude and a speed of the airframe, an engine speed and a throttle angle indicating a status of the airframe, and flight data such as a location and a direction of the airframe indicating a state of the flight.

The unmanned helicopter 1 can preferably fly using such autonomous control. In addition to operating by the autonomous control, as described above, the helicopter 1 can be flown via manual operation by an operator. Such manual operation is performed by the operator visually inspecting an attitude, a speed, an altitude, a direction, and so forth of the helicopter 1, while the operator operates a remote control device or a remote controller depending on various data transmitted from the airframe.

An antenna support frame 18 is mounted on the bottom surface of the main body 2. An inclining stay 19 is mounted on the antenna support frame 18. A navigation data antenna 20 is mounted on the stay 19 for transmitting navigation data (e.g., digital data) such as airframe data and flight data for the autonomous control described above to and from the ground station. Further, an image data antenna 21 is mounted on the stay 19 for transmitting image data photographed by the camera device 14 to the ground station by analog image communication transmission. Besides the analog transmission, a digital signal transmission can be adopted for the image communication.

An azimuth sensor 22 based on ground geo-magnetism or the like is provided to the bottom surface under the tail body 3. The azimuth sensor 22 detects a direction in which the airframe points (e.g., east, west, south, and north). In addition, an attitude sensor 40 including a gyro device (refer to FIG. 4) is provided inside of the main body 2.

A main GPS antenna 23 and a sub-GPS antenna 24 are provided on the upper surface of the tail body 3. The embodiment describes an example in which two GPS antennas are provided. However, the number of GPS antennas is not limited to the example described above. A plurality of GPS antennas such as three or four antennas may be provided (for example, an auxiliary GPS antenna 25 shown in the drawing by a phantom line).

A remote control receiving antenna 26 for receiving an instruction signal from the remote controller is provided at the rear end of the tail body 3.

FIG. 4 shows a block diagram of the unmanned helicopter according to one embodiment.

The camera device 14 has the infrared camera (or the CCD camera) 27 mounted on the camera mount 15. The camera mount 15 includes a panning mount 15A rotatable in the horizontal plane or, in other words, rotatable around a vertical shaft (e.g., a pan shaft) and a tilting mount 15B rotatable in the vertical plane or, in other words, rotatable around a horizontal shaft (e.g., a tilt shaft). The camera mount 15 is provided with a pan gyro 28A and a tilt gyro 28B for detecting an inclination respectively. Further, the camera device 14 has a camera controller 30 for receiving only a low frequency component from which a high frequency component has been removed via low-pass filters 29A and 29B based on data on the pan gyro 28A and the tilt gyro 28B. The camera device 14 is provided with a pan motor 31 and a tilt motor 32 for operating the panning mount 15A and the tilting mount 15B based on a signal of the camera controller 30.

The camera controller 30, the pan gyro 28A, the tilt gyro 28B, the pan motor 31, and the tilt motor 32 provide an attitude correction section of the camera 27. In the camera device 14, when a swing (inclination) in the direction of yawing (around the pan shaft) or in the direction of pitching (around the tilt shaft) of the unmanned helicopter 1 is detected, a motor is actuated in the direction opposite to the direction of the tilt to cancel the inclination (e.g., to cancel vibration).

The autonomous control box 17 houses an image control device 33 for receiving image data from the camera 27 from which a low frequency component of vibration has been removed by the attitude correction section in order to remove a high frequency component. The autonomous control box 17 also houses an image communication device 34 for transmitting image data to the ground station, a data communication device 35 for transmitting data for the autonomous control of the helicopter 1 to and from the ground station, a control board 36 including a microcomputer and the like for storing an autonomous control program, a main GPS receiver 37 connected with the main GPS antenna 23, and a sub-GPS receiver 38 connected with the sub-GPS antenna 24.

When the auxiliary GPS antenna 25 is provided, an auxiliary GPS receiver 39 is housed in the autonomous control box 17 in a similar manner. In the illustrated embodiment, the main GPS device includes the main GPS receiver 37 and the main GPS antenna 23, and the sub-GPS device includes the sub-GPS receiver 38 and the sub-GPS antenna 24. In addition, an auxiliary GPS device can be constructed with the auxiliary GPS receiver 39 and the auxiliary GPS antenna 25 if the auxiliary GPS receiver 39 and the auxiliary GPS antenna 25 are provided.

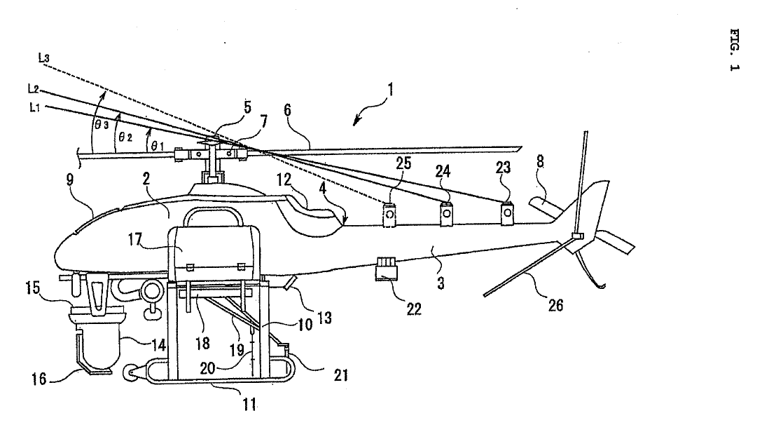

The image data antenna 21 for transmitting image data (e.g., analog image date) from the image communication device 34 in the autonomous control box 17 to the ground station, and the navigation data antenna 20 for transmitting navigation data (e.g., digital navigation data) between the data communication device 35 and the ground station are provided to the bottom surface of the main body 2 (refer to FIG. 1) of the airframe 4 as described above. The azimuth sensor 22 is connected with the control board 36 in the autonomous control box 17. The attitude sensor 40, including a gyro device and the like, is provided inside of the airframe 4. The attitude sensor 40 is connected with a control box 41. The control box 41 performs data communication with the control board 36 in the autonomous control box 17 and actuates five servo motors 42. Three of the servo motors 42 control the main rotor 5 and, with the servo motor 42 for the engine control, further control a movement of the airframe 4 in the longitudinal direction, the width direction, and the perpendicular direction. In addition, the servo motor 42 for controlling the tail rotor controls the rotation of the airframe 4.

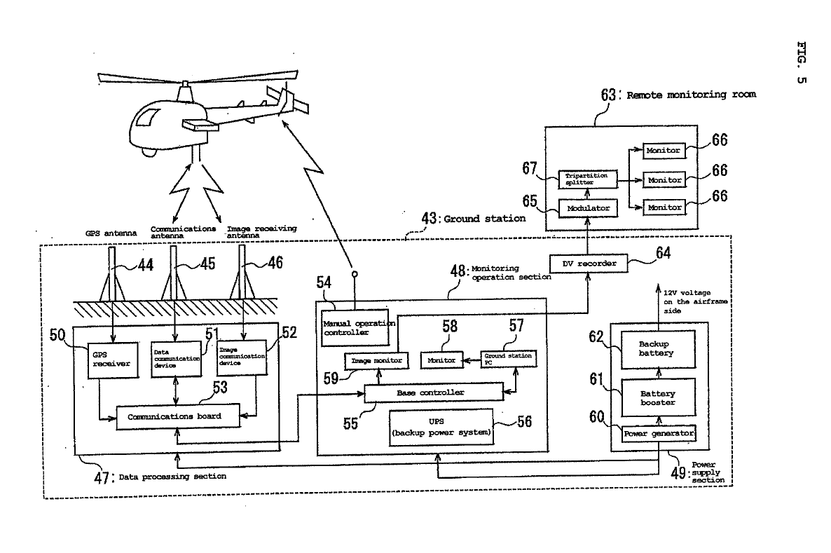

FIG. 5 shows a block diagram of a ground station.

A ground station (a standard station) 43 for communicating with the unmanned helicopter 1 is provided with a GPS antenna 44 for receiving signals from GPS satellites, a communications antenna 45 for performing data communication to and from the unmanned helicopter 1, and an image receiving antenna 46 for receiving image data from the unmanned helicopter 1. These three antennas are provided on the ground.

The ground station (the standard station) 43 includes a data processing section 47, a monitoring operation section 48, and a power supply section 49.

The data processing section 47 includes a GPS receiver 50, a data communication device 51, an image communication device 52, and a communication board 53 connected with these communicating devices 50, 51, and 52.

The monitoring operation section 48 includes a manual operation controller (e.g., remote controller) 54, a base controller 55 for operating the camera device 14, navigating and adjusting the airframe 4, a backup power supply 56, a personal computer 57 connected with the base controller 55, a monitor 58 for the personal computer, and an image monitor 59 connected with the base controller 55 for displaying image data.

The power supply section 49 includes a power generator 60 and a backup battery 62 connected with the power generator 60 via a battery booster 61. The backup battery 62 is connected with the side of the airframe 4 to supply electric power of 12V when the power generator 60 is not operated, for example, while a check is made before a flight. Moreover, the power supply section 49 supplies electric power of 100V from the power generator 60 to the data processing section 47 and the monitoring operation section 48 while the helicopter 1 is flying.

Image data displayed on the image monitor 59 of the ground station (the standard station) 43 is transmitted to a remote monitoring room 63 via a digital video (DV) recorder 64. The remote monitoring room 63 is provided with a modulator 65 for receiving and modulating image data and also with a splitter 67 (a splitter for a tripartition in the drawing) for separating image data having been modulated and displaying the image date on a plurality of monitors 66 (three monitors in the drawing). In other words, image received by the ground station 43 can be viewed on the three monitors 66 in the remote monitoring room 63.

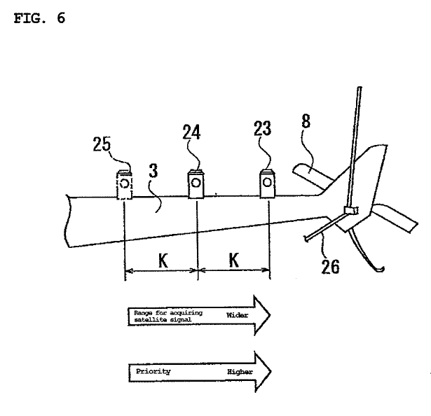

FIG. 6 shows an explanatory drawing of an arrangement of GPS antennas, enlarging the rear part of the tail body 3. As shown in the drawing, the main GPS antenna 23 and the sub-GPS antenna 24 (and the auxiliary GPS antenna 25) are arranged in line and spaced from each other along the longitudinal direction of the tail body 3 on the upper surface of the tail body 3. The positions in which the antennas 23 to 25 are mounted are set based on a priority described below.

Specifically, the main GPS antenna 23 that communicates with the highest priority GPS receiver 37 is positioned in the most rearward position on the airframe 4, while the sub-GPS antenna 24 that communicates with the next highest priority GPS receiver 38 is positioned frontwardly of the main GPS antenna 23.

The GPS antenna 25 that communicates with the lowers priority GPS receiver 39 is positioned frontwardly of all other GPS antennas on the airframe 4.

In other words, the GPS antenna of the GPS device with a higher priority is positioned rearwardly of the position of the GPS antenna of the GPS device with a lower priority. In the embodiment, as shown in FIG. 6, the main GPS antenna 23 and the sub-GPS antenna 24 (and the auxiliary GPS antenna 25) are arranged in descending order of priority from the rear of the airframe 4.

The positions of the GPS antennas are determined in accordance with the priority of the GPS devices. This is because the distance from a metal component such as the main shaft 5 and the rotor support section 7 becomes longer when the GPS antenna is disposed in a position as rearward as possible on the tail body 3. In other words, as the GPS antenna is positioned in the vicinity of the rear end of the tail body 3, radio wave signals from GPS satellites are less easily interrupted by the metal components described above. As a result, radio waves from GPS satellites are received in a wider range by the GPS antenna. Consequently, radio waves are received in a good condition. Specifically, as indicated by lines L1, L2, and L3 in FIG. 1, shielding angles θ1, θ2, and θ3 become smaller as the GPS antenna is positioned in a more rearward position on the tail body 3. Accordingly, a range for acquiring GPS satellites becomes wider.

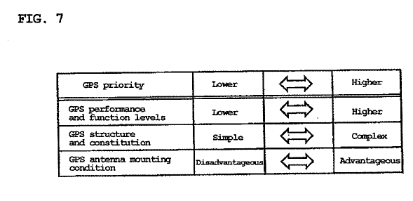

As shown in the table in FIG. 7, the priority of the GPS devices described above is determined according to performance and function levels of the GPS device, a structure and a constitution of the GPS device, and a mounting condition of the GPS antenna (e.g., a range for acquiring a satellite signal). For example, if the RTK-GPS, the DGPS, and the Single GPS described above are compared, the priority is set in the order of the RTK-GPS, the DGPS, and the Single GPS. In other words, the priority of the RTK-GPS is the highest, the priority of the DGPS is the second highest, and the priority of the Single GPS is the lowest.

A distance K between antennas (refer to FIG. 6) is set to a length between one wavelength and two wavelengths of a GPS radio wave in order to reduce an influence of a reflected wave caused by each GPS antenna. Specifically, since one wavelength of the GPS radio wave is about 20 cm (precisely, λ=19 cm), the distance K can be set to about 30 cm, which is between one wavelength, 20 cm, and two wavelengths, 40 cm.

In one embodiment, the RTK-GPS for which the ground station 43 is the standard station is mounted as the main GPS device in descending order of priority and, in addition, the Single GPS is mounted as a sub-GPS device on the unmanned helicopter, in which the GPS devices are switched according to a status of receiving a radio wave from GPS satellites.

As described above, the auxiliary GPS device including the auxiliary GPS antenna 25 and the auxiliary GPS receiver 39 may be provided. In such a case, the auxiliary GPS device may be the Single GPS and the sub-GPS device may be the DGPS. Alternatively, GPS devices of different manufactures are provided. GPS devices of different manufactures can be provided because software for performing positioning is different from manufacturer to manufacturer and thereby a slight difference may be caused in a positioning accuracy.

Moreover, there may be a case in which the main GPS device causes a failure due to an error in a software program (hereinafter referred to as a “bug”). If a GPS device of the same manufacturer is used as the sub-GPS device or the auxiliary GPS device, the software of the GPS device may contain the same bug. Consequently, the GPS devices may cause a failure in the same manner with the main GPS device. However, when a GPS device of a different manufacturer is used as the sub-GPS device or the auxiliary GPS device, accurate positioning can be better ensured by using the GPS device.

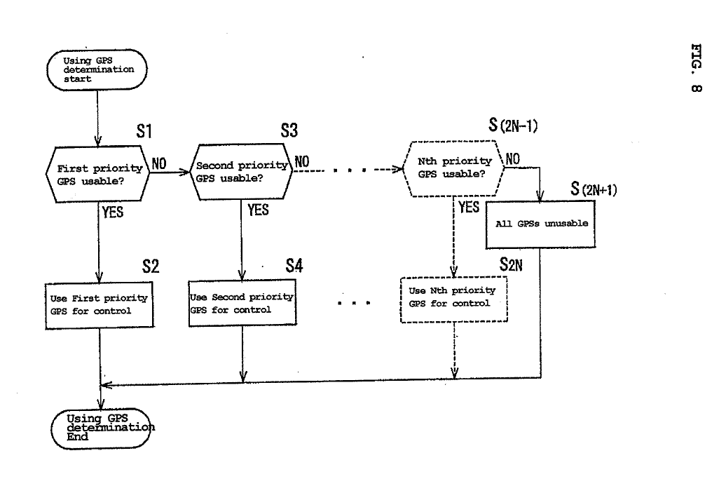

FIG. 8 shows a flow chart illustrating a switching control of a GPS device. Procedures illustrated in the flow chart are repeatedly followed at predetermined intervals during a flight of the unmanned helicopter 1. The procedure of each step will be described hereinafter.

Step S1: When the unmanned helicopter 1 starts flying, it is determined whether or not the GPS device with the first priority can be used. If the GPS device with the first-place priority can be used, the procedure proceeds to a step S2. On the other hand, if the GPS device cannot be used, the procedure proceeds to a step S3. In the embodiment, in other words, it is determined whether or not the RTK-GPS can be applied. Specifically, it is determined whether or not data reception from the ground station (the standard station) 43 is good and further whether or not radio waves can be continuously received from four or more GPS satellites (five or more GPS satellites in the initial state).

Step S2: The GPS device with the first priority is used as the sensor for detecting a current location of the helicopter 1 in the autonomous control, and the procedure for determining the GPS device for a current use is ended.

Step S3: After this, it is determined whether or not the GPS device with the second priority can be used. If the GPS device with the second priority can be used, the procedure proceeds to a step S4. On the other hand, if the GPS device cannot be used, the procedure proceeds to a step S(2N−1). In the embodiment, it is determined whether or not the single GPS can be used. Specifically, it is determined whether or not radio waves can be received from a plurality of GPS satellites (for example, three or more GPS satellites). When, for example, the DGPS is in use as the GPS device with the second priority, it is determined whether or not reception of correction data from the ground station (the standard station) is good and further whether or not radio waves can be received from a plurality of GPS satellites (for example, three or more GPS satellites).

Step S4: The GPS device with the second priority is used as the sensor for detecting a current location of the helicopter 1 in the autonomous control, and the procedure for determining the GPS device for a current use is ended.

Determination is repeatedly made sequentially as described above from a GPS device with a higher priority to a GPS device with a lower priority. The determination described above is continued to a GPS device with the Nth priority, where N is the lowest priority.

Step S(2N−1): It is determined whether or not the GPS device with the Nth priority can be used. If the GPS device with the Nth priority can be used, the procedure proceeds to a step S(2N). On the other hand, if the GPS device cannot be used, the procedure proceeds to a step S(2N+1).

Step S(2N): The GPS device with the Nth priority is used as the sensor for detecting a current location of the helicopter 1 in the autonomous control, and the procedure for determining the GPS device for a current use is ended.

Step S(2N+1): It is determined that all the GPS devices cannot be used, and the procedure for determining the GPS device for a current use is ended.

In a case where all the GPS devices cannot be used, a flight by autonomous control is continued by using a relative location stored as past data and by further using the azimuth sensor 22 until a usable GPS device can be found by determining the GPS device in current use (e.g., the procedure for determining the GPS device in current use) performed at predetermined intervals.

According to one embodiment, the autonomous control section (the control board 36) has the GPS devices of two different types—the RTK-GPS and the Single GPS. In the unmanned helicopter 1, the Single GPS as the sub-GPS device (e.g., the GPS receiver 38 and the GPS antenna 24) is used when the RTK-GPS by the main GPS device (e.g., the GPS receiver 37 and the GPS antenna 23) becomes unusable because the number of GPS satellites capable of receiving radio waves is less than a desired number or because data communication from the ground station 43 is interrupted.

Because the sub-GPS device (e.g., the GPS receiver 38 and the GPS antenna 24) has a different positioning system type from that of the main GPS device (e.g., the GPS receiver 37 and the GPS antenna 23), the sub-GPS device does not become unusable in the same manner as the main GPS device even in a situation in which the main GPS device becomes unusable.

Therefore, according to the unmanned helicopter 1, even if the number of GPS satellites from which radio waves are received is less than a desired number, or even if data communication with the ground station 43 is interrupted, a current location of the airframe 4 can be always detected. Thus, a program flight of the helicopter 1 by autonomous control can be performed.

Further, the control board 36 can set the RTK-GPS as the main GPS device and uses the Single GPS as the sub-GPS device. Then, the control board 36 sets priority in accordance with a function and an accuracy of the GPS devices and thereby switches the GPS devices depending on a status of transmission or the like in descending order of priority for use. Specifically, in the unmanned helicopter 1 according to the illustrated embodiment, the RTK-GPS as the main GPS device (e.g., the GPS receiver 37 and the GPS antenna 23) detects a current position of the helicopter 1 with high accuracy during a normal flight and performs a program flight by accurate autonomous control. On the other hand, if the Single GPS, which is of a simple structure and strong and simple, is used as the sub-GPS device (e.g., the GPS receiver 38 and the GPS antenna 24), a current location is surely detected.

Further, in the unmanned helicopter 1 according to the illustrated embodiment, the GPS antennas 23, 24, and 25 are arranged frontwardly from the rearward position on the upper surface on the tail body 3 in descending order of priority of the GPS devices. Therefore, the GPS antenna 23 with a high priority is in a position spaced rearward from a metal section such as the main shaft 5 of the main rotor 6, the rotor support section 7, and the like. Consequently, in the unmanned helicopter 1, the GPS antenna 23 of a GPS device with a high priority is not interrupted by the main shaft 5, the rotor support section 7, or the like but receives radio waves from GPS satellites.

Still further, in the unmanned helicopter 1, each distance between a plurality of the GPS antennas 23, 24, and 25 can be set to a length (about 30 cm) between one wavelength (about 20 cm) and two wavelengths (about 40 cm) of a radio wave of the GPS. Therefore, an influence over the GPS antennas 23, 24, and 25 caused by a reflected wave reflected on the other adjoining GPS antennas 23, 24, and 25 can be reduced.

Advantageously, the autonomous control section of the aircraft in the embodiments disclosed herein can have a plurality of different GPS devices, so it is possible to have a GPS device on standby in addition to a GPS device in use. When the main GPS device in use becomes unusable, for example, because the number of GPS satellites from which radio waves are received is less than a desired number or because data communication is interrupted, a different GPS device can be used to detect a current location of the airframe 4. Consequently, it is possible to continue a program flight by autonomous control.

The autonomous control section of the aircraft (e.g., the unmanned helicopter 1) can include a GPS device that employs a method for detecting a location that differs from that of a plurality of different GPS devices. The autonomous control section can also include a plurality of GPS devices, wherein each device is from a different manufacturer. Using GPS devices from different manufacturers ensures that the correct location of an aircraft (e.g., the helicopter 1) can be detected even if one of the GPS devices develops an abnormality and becomes unusable, since devices from different manufacturers are unlikely to have the same abnormality. Thus, the aircraft can continue to perform a program flight by autonomous control.

An example of such different GPS device types includes, for example, a GPS device having a difference in a method of detecting a location or, in other words, a method of positioning control. Such a difference can include a difference in a desired number of GPS devices from which transmission is received to determine the location of the aircraft, and a desired data or the like from a standard station or the like. Moreover, even if a positioning control method is the same, internal software, the receiver sensitivity of each sensor, and so forth are different from manufacturer to manufacturer. Additionally, the usability of different GPS device types in each situation is different. Accordingly, even when a current location cannot be detected by a main GPS device, the current location can be detected by another GPS device.

Advantageously, the autonomous control section sets the priority of each of a plurality of GPS devices in accordance with a function and an accuracy thereof, and thereby switches a plurality of the GPS devices depending on a transmission condition or the like in descending order of priority for use. Therefore, the GPS device that is mainly used can have a high function, and another GPS device can perform positioning in a wide range. Thus, it is possible to ensure detection of a current location in any situation.

As discussed above, the GPS antenna of a GPS device with a high priority can be spaced from a metal section (e.g., the main shaft 5 and a rotor support section 7 of the main rotor 5) and the like provided on the main body 2 of the helicopter 1. Such an arrangement advantageously inhibits the interruption of a radio wave transmission (e.g., by the main shaft, rotor support section, etc.) from a GPS satellite to the GPS antenna of the high priority GPS device. Further, a distance of the GPS antennas disposed on the tail body 3 of the helicopter 1 can be set to be a length between one wavelength and two wavelengths of a GPS radio wave. Consequently, an influence of a wave reflected between adjacent GPS antennas can be reduced.

The GPS sensing system described above in connection with the helicopter 1 is not limited for use in connection with helicopters, but can be applied to other aircraft, including an unmanned helicopter for photographing an aerial photograph and, in addition to this, can be utilized for a small unmanned helicopter for performing a program flight by autonomous control on a predetermined route such as an unmanned helicopter for applying agrochemicals.

Although these inventions have been disclosed in the context of a certain preferred embodiments and examples, it will be understood by those skilled in the art that the present inventions extend beyond the specifically disclosed embodiments to other alternative embodiments and/or uses of the inventions and obvious modifications and equivalents thereof. In addition, while a number of variations of the inventions have been shown and described in detail, other modifications, which are within the scope of the inventions, will be readily apparent to those of skill in the art based upon this disclosure. It is also contemplated that various combinations or subcombinations of the specific features and aspects of the embodiments may be made and still fall within one or more of the inventions. Accordingly, it should be understood that various features and aspects of the disclosed embodiments can be combined with or substituted for one another in order to form varying modes of the disclosed inventions. Thus, it is intended that the scope of the present inventions herein disclosed should not be limited by the particular disclosed embodiments described above.

1-6. (canceled)

7. An unmanned helicopter, comprising:
an airframe with a plurality of GPS antennas disposed thereon, the GPS antennas configured to receive a signal from at least one GPS satellite; and
an autonomous controller configured to control the helicopter based at least in part on airframe data and flight route data and to communicate with a ground station, the controller comprising a plurality of GPS receivers, each receiver corresponding to one of the plurality of GPS antennas and defining therewith a GPS device configured to detect a location of the airframe, the GPS devices being different from each other.

8. The unmanned helicopter of claim 7, wherein the autonomous controller comprises a control board with a built-in data communication device for communicating with the ground and a built-in control program.

9. The unmanned helicopter of claim 7, wherein the airframe data includes at least one of attitude and speed.

10. The unmanned helicopter of claim 7, wherein the flight route data includes at least one of airframe location and airframe direction.

11. The unmanned helicopter of claim 7, wherein the different GPS devices are from different manufacturers.

12. The unmanned helicopter of claim 7, wherein the different GPS devices are configured to detect a location of the airframe in a different manner.

13. The unmanned helicopter of claim 7, wherein the autonomous controller is configured to assign priorities to the plurality of GPS devices based at least on a function and an accuracy of the GPS devices, and is configured to use the GPS devices in descending order of priority.

14. The unmanned helicopter of claim 13, wherein the airframe comprises a main body and a tail body, the plurality of GPS antennas arranged in line along a longitudinal direction of the airframe on the tail body, and wherein the GPS antenna of a GPS device with a higher priority is positioned rearwardly of a GPS antenna of a GPS device with a lower priority.

15. The unmanned helicopter of claim 14, wherein the GPS antennas are spaced apart from each other a length of between one wavelength and two wavelengths of a radio wave of the signal from the GPS satellite.

16. An unmanned helicopter, comprising:
an airframe with a plurality of GPS antennas disposed thereon, the GPS antennas configured to receive a signal from at least one GPS satellite, the GPS antennas being spaced apart from each other a length of between one wavelength and two wavelengths of a radio wave of the signal from the GPS satellite; and
an autonomous controller configured to navigate the helicopter based at least in part on airframe data and flight route data and to communicate with a ground station, the controller comprising a plurality of GPS receivers, each receiver corresponding to one of the plurality of GPS antennas and defining therewith a GPS device configured to detect a location of the airframe, the GPS devices being different from each other.

17. The unmanned helicopter of claim 16, wherein the autonomous controller is configured to assign priorities to the plurality of GPS devices based at least on a function and an accuracy of the GPS devices, and is configured to use the GPS devices in descending order of priority.

18. The unmanned helicopter of claim 17, wherein the GPS antenna of a GPS device with a higher priority is positioned rearwardly of a GPS antenna of a GPS device with a lower priority

19. The unmanned helicopter of claim 17, wherein the autonomous controller is configured to switch detection of the location of the airframe from a first GPS device to a second GPS device when the first GPS device becomes unusable, the first GPS device having a higher priority than the second GPS device.

20. A method for operating an unmanned helicopter having a plurality of GPS devices, comprising:
assigning a priority to a plurality of GPS devices on the helicopter;
determining whether the GPS device with the first priority is usable; and
sensing a location of the helicopter with the GPS device with the first priority when the GPS device with the first priority is usable.

21. The method of claim 20, wherein determining comprises whether data reception from a ground station is available and whether a signal can be continuously received by the GPS device with the first priority from a desired number of GPS satellites.

22. The method of claim 20, further comprising:
determining whether the GPS device with the second priority is usable if the GPS device with the first priority is determined to not be usable; and
sensing the location of the helicopter with the GPS device with the second priority if the GPS device with the second priority is usable.

23. The method of claim 20, wherein assigning the priority to the plurality of GPS devices comprises at least one of comparing the performance and function levels of the GPS devices, comparing the structure and constitution of the GPS devices and comparing the mounting condition of the GPS antenna associated with each of the GPS devices.

24. The method of claim 23, wherein assigning includes assigning a higher priority to the GPS device with a higher performance and function level.

25. The method of claim 23, wherein assigning includes assigning a higher priority to the GPS device with a complex structure and constitution.

26. The method of claim 23, wherein assigning includes assigning a higher priority to the GPS device with a greater range for acquiring a signal from a GPS satellite.
